(19) United States
(12) Patent Application Publication
(10) Pub. No.: US 2015/0298579 A1
(43) Pub. Date: Oct. 22, 2015

(54) LOCKING DEVICE FOR A VEHICLE SEAT, ARRANGEMENT OF AT LEAST TWO LOCKING DEVICES AND VEHICLE SEAT

(71) Applicant: JOHNSON CONTROLS GMBH, Burscheid (DE)

(72) Inventor: Boris Juelich, Kuerten (DE)

(73) Assignee: JOHNSON CONTROLS GMBH, Burscheid (DE)

(21) Appl. No.: 14/646,151

(22) PCT Filed: Oct. 17, 2013
(86) PCT No.: PCT/EP2013/071721

§ 371 Date: May 20, 2015

(30) Foreign Application Priority Data
Nov. 28, 2012 (DE) 10 2012 023 685.9

(51) Int. Cl. B60N 2/015; B60Q 3/02

(52) U.S. Cl. CPC B60N 2/0155; B60Q 3/0286

(57) ABSTRACT

A locking device (10) for a vehicle seat includes a detent (13) for securing a rotary latch (11) and a light source (41). When the locking device (10) is completely locked, a light beam emitted from the light source (41) penetrates the locking device (10) in the axial direction.

### CROSS REFERENCE TO RELATED APPLICATIONS

This application is a United States National Phase Application of International Application PCT/EP2013/071721 filed Oct. 17, 2013 and claims the benefit of priority under 35 U.S.C. §119 of German Patent Application DE 10 2012 023 685.9 filed Nov. 28, 2012, the entire contents of which are incorporated herein by reference.

### FIELD OF THE INVENTION

The invention relates to a locking device for a vehicle seat, comprising a latching pawl for securing a rotary catch, and a light source. The invention also relates to an arrangement of at least two locking devices and to a vehicle seat having the features of claim 1 the arrangement of at least two locking devices.

### BACKGROUND OF THE INVENTION

A locking device of the generic type for a vehicle seat is known from DE 10 2008 051 832 A1. A locking device of this type comprises a pivotably mounted rotary catch for locking to a pin. A latching pawl which is pivotably mounted about another pivot axis secures the rotary catch in the locked state. A tolerance compensation pawl exerts a closing torque on the rotary catch and in this way eliminates play which exists between the rotary catch and the pin.

The latching pawl and the tolerance compensation pawl are arranged on a bearing pin such that they can be pivoted about the same pivot axis, offset axially next to one another, and interact with the rotary catch. In the case of a crash, only the latching pawl secures the rotary catch, by the rotary catch being supported at a contact point on the latching pawl. The crash load which the pin transmits to the rotary catch in the case of a crash is absorbed here by the contact point of the rotary catch with the latching pawl.

If the locking device is locked, the rotary catch is situated in the locked position, said rotary catch engaging around the pin, and the latching pawl is situated in the securing position, said latching pawl securing the rotary catch. If the locking device is unlocked, the rotary catch is situated in the unlocked position, said rotary catch releasing the pin, and the latching pawl is situated in the release position, said latching pawl releasing the rotary catch.

It is extremely important for a user of the vehicle seat that all the locking devices of the vehicle seat are completely locked. If a locking device is unlocked, the vehicle seat can become detached from the vehicle structure during a crash, which can lead to injuries of the user. It is also a problem if a locking device is only partially locked; although the rotary catch receives the pin, the latching pawl is not situated in the securing position. The rotary catch is also not secured in this case and can open the locking device in the case of a crash.

DE 102 30 637 A1 has disclosed a locking device for a vehicle seat, which locking device permits a visual display of the locking state. If the locking device is not locked, a light source transmits a light beam via a light guide to a light outlet point, where the non-locked state is displayed visually. If the locking device is locked, the light beam which is transmitted by the light source is interrupted and therefore does not reach the light outlet point. The interruption of the light beam takes place by means of a linearly displaceable slide. Here, the slide is coupled via a lever mechanism to a latching pawl which is called a detent, is mounted pivotably and secures a rotary catch if the locking device is locked.

### SUMMARY OF THE INVENTION

The invention is based on an object of improving a locking device for a vehicle seat of the type mentioned at the outset, in particular of making a display of the locking state of the locking device or a plurality of locking devices possible and of simplifying the construction of the locking device, and of providing a corresponding vehicle seat.

According to the invention, a locking device of a generic type for a vehicle seat comprises a latching pawl for securing a rotary catch, and a light source. The locking device is provided according to the invention that, if the locking device is completely locked, a light beam which is emitted by the light source penetrates the locking device in the axial direction.

This arrangement makes a comparatively simple structural construction of the locking device possible. Elements which already exist in the locking device, in particular the rotary catch or the latching pawl, can allow the light beam to pass or can interrupt it depending on their position if the locking device is locked or unlocked. An additional mechanism for interrupting the light beam is therefore not required.

If the locking device is unlocked, and advantageously also if the locking device is only partially locked, the light beam which is emitted by the light source is interrupted within the locking device by an element which is already present in the locking device. A visual determination of the locking state of the locking device is therefore possible.

According to one advantageous refinement of the invention, the latching pawl assumes the function of interrupting the light beam.

To this end, the latching pawl has a passage opening which the light beam which is emitted by the light source penetrates if the locking device is completely locked.

If the locking device is unlocked, the light beam which is emitted by the light source strikes the latching pawl and is therefore interrupted by the latching pawl.

The latching pawl is preferably arranged within a housing which comprises a first housing part and a second housing part.

According to one advantageous development of the invention, a first passage opening is provided in the first housing part and a second passage opening is provided in the second housing part. If the locking device is completely locked, the light beam which is emitted by the light source penetrates the first passage opening and the second passage opening.

If the locking device is completely locked, a center of the third passage opening which is provided in the latching pawl lies on a throughway line which is defined by a center of the first passage opening and a center of the second passage opening. The light beam can therefore penetrate the housing of the locking device in a rectilinear manner.

Here, the throughway line advantageously runs in the axial direction.

The passage openings in the housing parts and in the latching pawl can be manufactured comparatively simply if the first passage opening and/or the second passage opening and/or the third passage opening are/is configured as a circular hole.

The construction of the locking device is particularly compact if the light source is fastened directly to the first housing part or to the second housing part.

In one simple refinement, the light source comprises only a fiber optic cable.

If the light source comprises a mirror, the light beam can be diverted, in particular from a direction which runs perpendicularly with respect to the axial direction into the axial direction.

A light receiver is advantageously provided which is struck by the light beam which is emitted by the light source if the locking device is completely locked.

In one simple refinement, the light receiver comprises only a fiber optic cable.

If the light receiver comprises a mirror, the light beam can be diverted, in particular from the axial direction into a direction which runs perpendicularly with respect thereto.

The object is also achieved by way of an arrangement of at least two locking devices according to the invention, the light receiver of the first locking device being connected by means of a fiber optic cable to the light source of the second locking device. This allows a visual test as to whether both locking devices are completely locked.

The object is also achieved by way of a vehicle seat, which vehicle seat comprises at least one locking device according to the invention.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a cross section through a locking device in the completely locked state;

FIG. 2 is a longitudinal section through the locking device from FIG. 1 in the completely locked state;

FIG. 3 is a cross section through a locking device in the partially locked state;

FIG. 4 is a longitudinal section through the locking device from FIG. 3 in the partially locked state; and

FIG. 5 is an arrangement for displaying the locking state of a plurality of locking devices.

### DESCRIPTION OF THE PREFERRED EMBODIMENTS

A vehicle seat (not shown) can be fastened to a vehicle structure by means of a plurality of locking devices 10. Here, two locking devices 10 are provided in a rear region (in the driving direction) of the vehicle seat, in each case one of said locking devices 10 being arranged on the right in the driving direction and the other of said locking devices 10 being arranged on the left in the driving direction. Two further locking devices 10 are likewise provided in a front region (in the driving direction) of the vehicle seat, in each case one of said locking devices 10 being arranged on the right in the driving direction and the other of said locking devices 10 being arranged on the left in the driving direction.

In the completely locked state, a rotary catch 11 of the locking device 10 engages around a pin which is arranged on the vehicle structure. In the unlocked state of the locking device 10, the rotary catch 11 is pivoted about a first pivot axis 71 and releases the pin. For unlocking, an unlocking lever 16 which is provided on a latching pawl 13 is pivoted about a second pivot axis 72, as a result of which the latching pawl 13 pivots away from the rotary catch 11 and releases the latter. A locking device 10 of this type is described, for example, in DE 10 2008 051 832 A1, the disclosure of which in this regard is expressly incorporated.

The first pivot axis 71 and the second pivot axis 72 run parallel to one another in a direction which will be called the axial direction in the following text. The pin which is arranged on the vehicle structure also runs in the axial direction in the present case.

A tolerance compensation pawl which is likewise mounted such that it can be pivoted about the second pivot axis 72 is provided to compensate for manufacturing tolerances.

The rotary catch 11, the latching pawl 13 and further components of the locking device 10 are arranged within a housing which comprises a first housing part 21 and a second housing part 22 in the present case. One of the two housing parts 21, 22 (the second housing part 22 in the present case) is connected to a structural part 5 of the vehicle seat here. The housing parts 21, 22 largely accommodate the remaining components of the locking device 10 between them.

The housing parts 21, 22 are of approximately flat configuration and define planes which lie offset in parallel to one another and run perpendicularly with respect to the pivot axes 71, 72.

A first passage opening 31 is provided in the first housing part 21. A second passage opening 32 is provided in the second housing part 22. A third passage opening 33 is provided in the latching pawl 13. In the present case, the passage openings 31, 32, 33 are configured as circular holes.

The center of the first passage opening 31 and the center of the second passage opening 32 define a throughway line 75 which lies parallel to the pivot axes 71, 72 and runs in the axial direction. The third passage opening 33 is arranged in such a way that, in the completely locked state of the locking device 10 when the latching pawl 13 secures the rotary catch 11, its center also lies on the throughway line 75, that is to say is aligned with the center of the first passage opening 31 and the center of the second passage opening 32.

A light source 41 is arranged outside the housing of the locking device 10, in the vicinity of the first passage opening 31. In the present case, the light source 41 is fastened to the first housing part 21, on the side which faces away from the second housing part 22.

A light receiver 42 is arranged outside the housing of the locking device 10, in the vicinity of the second passage opening 32. In the present case, the light receiver 42 is fastened to the structural part 5 of the vehicle seat, on the side which faces away from the first housing part 21. A fourth passage opening 34 is provided in the structural part 5 of the vehicle seat, which fourth passage opening 34 is likewise configured as a circular hole and the center of which lies on the throughway line 75. It is also conceivable that the light receiver 42 is fastened to the second housing part 22, on the side which faces away from the first housing part 21.

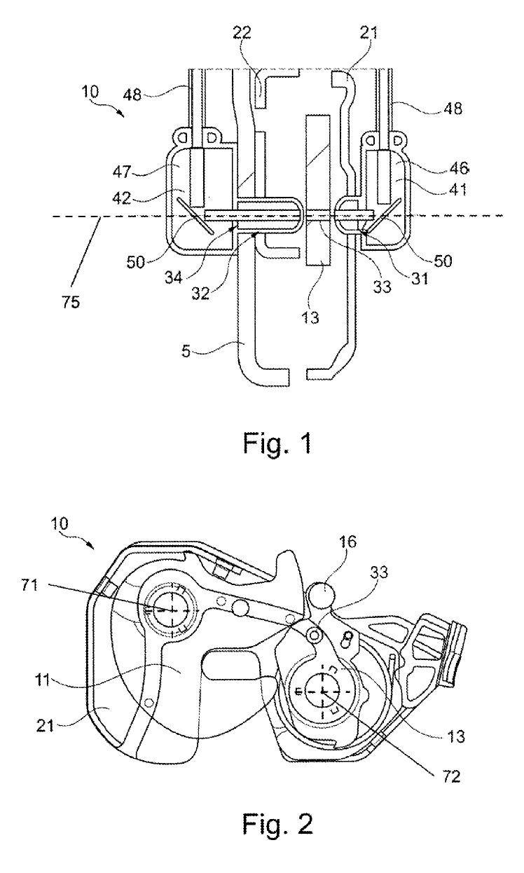

The locking device 10 is completely locked in the illustrations according to FIG. 1 and FIG. 2. The latching pawl 13 secures the rotary catch 11 and the third passage opening 33 therefore lies on the throughway line 75. A light beam which is emitted by the light source 41 runs in the axial direction through the first passage opening 31, through the third passage opening 33, through the second passage opening 32 and through the fourth passage opening 34 and strikes the light receiver 42.

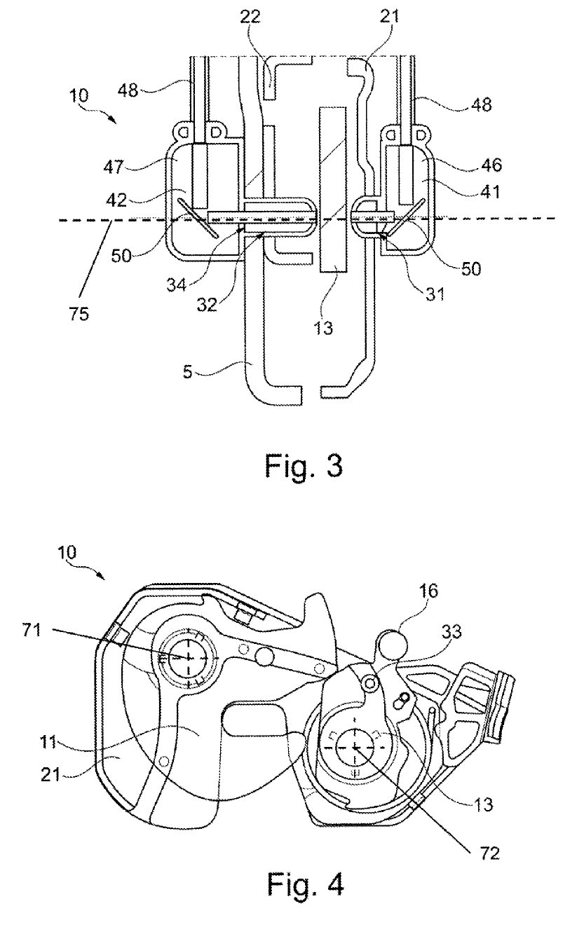

The locking device 10 is partially locked in the illustrations according to FIG. 3 and FIG. 4. The latching pawl 13 is pivoted away from the rotary catch 11 and does not secure the latter. The third passage opening 33 therefore lies away from the throughway line 75. A light beam which is emitted by the light source 41 passes through the first passage opening 31 and then strikes the latching pawl 13. In the present case, the latching pawl 13 is composed of metal and is opaque. The light beam is therefore interrupted and does not strike the light receiver 42.

It is also conceivable that the latching pawl 13 does not have a passage opening. In this case, the first passage opening 31, the second passage opening 32 and the fourth passage opening 34 are arranged in such a way that, if the locking device 10 is completely locked, the light beam which is emitted by the light source 41 runs in the axial direction through the first passage opening 31, past the unlocking lever 16 or another part of the latching pawl 13, through the second passage opening 32 and through the fourth passage opening 34 and strikes the light receiver 42. If the locking device 10 is partially locked and if the locking device 10 is not locked, the light beam which is emitted by the light source 41 strikes the unlocking lever 16 or another part of the latching pawl 13, is interrupted there and does not strike the light receiver 42.

The locking state of the locking device 10 can therefore be determined by way of an evaluation of a signal of the light receiver 42. If the light beam which is emitted by the light source 41 strikes the light receiver 42, the locking device 10 is completely locked. If the light beam which is emitted by the light source 41 does not strike the light receiver 42, the locking device 10 is not completely locked, that is to say is partially locked or unlocked.

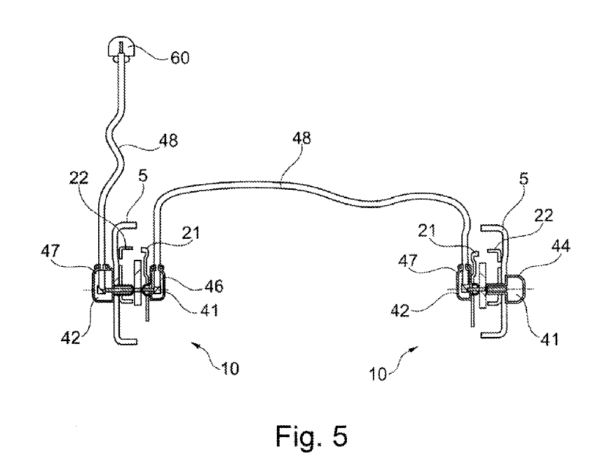

The light source 41 can be configured as an active illumination unit 44, for example as shown in FIG. 5, in the form of an LED. The light source 41 can also be configured, for example as in the present case, as a passive transmitting unit 46. In the present case, the transmitting unit 46 comprises in each case one fiber optic cable 48 which transports light which is generated by an external illumination device to the respective transmitting unit 46, and a mirror 50 which diverts the incoming light in the form of a light beam in the axial direction on to the first passage opening 31.

It is also conceivable that the abovementioned mirror is dispensed with, the transmitting unit 46 comprising, for example, a fiber optic cable 48 which is arranged in such a way that a light beam which emerges from the fiber optic cable 48 strikes the first passage opening 31 in the axial direction.

The light receiver 42 can be configured as a light-sensitive sensor, for example in the form of a photodiode. The light receiver 42 can also be configured, for example as in the present case, as a receiving unit 47. In the present case, the receiving unit 47 comprises a fiber optic cable 48 and a mirror 50 which diverts a light beam coming from the axial direction in the direction of the fiber optic cable 48.

It is also conceivable that the abovementioned mirror is dispensed with, the receiving unit 47 comprising, for example, a fiber optic cable 48 which is arranged in such a way that a light beam coming from the axial direction strikes the fiber optic cable 48.

The exemplary embodiment which is shown in FIG. 5 comprises an arrangement for displaying the locking state of two locking devices 10. In the illustration which is shown here, both locking devices 10 are completely locked.

The locking device 10 which is arranged on the right-hand side in the illustration which is shown comprises an illumination unit 44 in the form of an LED as light source 41 and a light receiver 42 which is configured as a receiving unit 47.

The locking device 10 which is arranged on the left-hand side in the illustration which is shown comprises a transmitting unit 46 as light source 41 and a light receiver 42 which is configured as a receiving unit 47.

By means of a first fiber optic cable 48, the receiving unit 47 of the locking device 10 which is arranged on the right-hand side is connected to the transmitting unit 46 of the locking device 10 which is arranged on the left-hand side. By means of a second fiber optic cable 48, the receiving unit 27 of the locking device 10 which is arranged on the left-hand side is connected to a display device 60.

In the present case, if both locking devices 10 are completely locked, the illumination unit 44 generates a light beam which strikes the receiving unit 47 of the locking device 10 which is arranged on the right-hand side. From there, the light beam is transmitted via the first fiber optic cable 48 to the transmitting unit 46 of the locking device 10 which is arranged on the left-hand side. From there, the light beam passes to the receiving unit 47 of the locking device 10 which is arranged on the left-hand side. From there, the light beam is transmitted via the second fiber optic cable 48 to the display device 60 which is arranged on a dashboard of the vehicle in the present case.

If the display device 60 is therefore lit, both locking devices 10 of the vehicle seat are completely locked. If one of the two locking devices 10 is not locked, its latching pawl 13 interrupts the light beam which runs in the axial direction and no light therefore arrives at the display device 60. If the display device 60 is therefore not lit, at least one of the two locking devices 10 of the vehicle seat is not completely locked.

Instead of the transmission of the light beam by means of fiber optic cables 48, it is also conceivable to convert the light beam which can be considered to be a visual signal into an electrical signal by means of a light receiver 42 which is configured as a photodiode and to transmit said electrical signal.

The electrical signal which is converted in this way and indicates the complete locking of the associated locking device 10 can then be transmitted via electrical lines to the dashboard or to a bus system of the vehicle.

If a locking device 10 is not completely locked, a visual display can take place in the dashboard. A haptic indication is likewise conceivable, for example by way of the generation of a vibration in the vehicle seat.

The features which are disclosed in the above description, the claims and the drawings can be of significance both individually and in combination for the implementing of the invention in its various refinements.

While specific embodiments of the invention have been shown and described in detail to illustrate the application of the principles of the invention, it will be understood that the invention may be embodied otherwise without departing from such principles.

1. A locking device for a vehicle seat, the locking device comprising:
a latching pawl for securing a rotary catch and
a light source for emitting a light beam, wherein with the locking device in a completely locked state, the light beam which is emitted by the light source penetrates the locking device in an axial direction.

2. The locking device as claimed in claim 1, wherein with the locking device in an unlocked state, the light beam which is emitted by the light source is interrupted within the locking device.

3. The locking device as claimed in claim 1, wherein the latching pawl has a passage opening which the light beam which is emitted by the light source penetrates with the locking device in a completely locked state.

4. The locking device as claimed in claim 3, wherein the light beam which is emitted by the light source strikes the latching pawl if with the locking device in an unlocked state.

5. The locking device as claimed in claim 1, wherein the latching pawl is arranged within a housing which comprises a first housing part and a second housing part.

6. The locking device as claimed in claim 5, wherein a first passage opening is provided in the first housing part and a second passage opening is provided in the second housing part, which passage openings are penetrated by the light beam which is emitted by the light source with the locking device in a completely locked state.

7. The locking device as claimed in claim 6, wherein, with the locking device in a completely locked state, a center of a third passage opening which is provided in the latching pawl lies on a throughway line which is defined by a center of the first passage opening and a center of the second passage opening.

8. The locking device as claimed in claim 7, wherein the throughway line runs in the axial direction.

9. The locking device as claimed in claim 7, wherein the first passage opening and/or the second passage opening and/or the third passage opening are/is configured as a circular hole.

10. The locking device as claimed in claim 5, wherein the light source is fastened to the first housing part or to the second housing part.

11. The locking device as claimed in claim 1, wherein the light source comprises at least one of a fiber optic cable and a mirror.

12. The locking device as claimed in claim 1, further comprising a light receiver which is struck by the light beam which is emitted by the light source with the locking device in a completely locked state.

13. The locking device as claimed in claim 11, wherein the light receiver comprises at least one of a fiber optic cable and a mirror.

14. A locking device arrangement for a vehicle seat, the locking device arrangement comprising:
a first locking device comprising a first device latching pawl for securing a first device rotary catch, wherein with the first locking device in a completely locked state, a light beam which penetrates the first locking device in an axial direction;
a second locking device comprising a second device latching pawl for securing a second device rotary catch, a light receiver and a light source for emitting a light beam, wherein with the second locking device in a completely locked state, the light beam which is emitted by the light source penetrates the locking device in the axial direction; and
a fiber optic cable, wherein the light receiver of the second locking device is connected by means of the fiber optic cable to the light source of the second locking device.

15. A vehicle seat, comprising a locking device, the locking device comprising:
a latching pawl;
a rotary catch, the locking pawl for securing a rotary catch; and
a light source for emitting a light beam, wherein with the locking device in a completely locked state, the light beam which is emitted by the light source penetrates the locking device in the an axial direction.

16. The vehicle seat as claimed in claim 15, wherein with the locking device in an unlocked state, the light beam which is emitted by the light source is interrupted within the locking device.

17. The vehicle seat as claimed in claim 15, wherein the latching pawl has a passage opening, which the light beam, which is emitted by the light source, penetrates with the locking device in a completely locked state.

18. The vehicle seat as claimed in claim 17, wherein the light beam which is emitted by the light source strikes the latching pawl with the locking device in an unlocked state.

19. The vehicle seat as claimed in claim 1, wherein the latching pawl is arranged within a housing which comprises a first housing part and a second housing part.

20. The vehicle seat as claimed in claim 19, wherein a first passage opening is provided in the first housing part and a second passage opening is provided in the second housing part, which passage openings are penetrated by the light beam which is emitted by the light source with the locking device in a completely locked state.
